(19) United States
(12) Patent Application Publication
(10) Pub. No.: US 2025/0365207 A1
(43) Pub. Date: Nov. 27, 2025

(54) METHODS, DEVICES, AND SYSTEMS FOR ANALYTICS-ENHANCED EDGE ENABLING LAYER SERVICE CONTINUITY

(71) Applicant: InterDigital Patent Holdings, Inc., Wilmington, DE (US)

(72) Inventors: Lu LIU, Conshohocken, PA (US); Dale SEED, Allentown, PA (US); Quang LY, North Wales, PA (US); Catalina MLADIN, Hatboro, PA (US)

(73) Assignee: InterDigital Patent Holdings, Inc., Wilmington, DE (US)

(21) Appl. No.: 19/126,683

(22) PCT Filed: Nov. 2, 2023
(86) PCT No.: PCT/US2023/078459

§ 371 Date: May 2, 2025

Related U.S. Application Data
(60) Provisional application No. 63/382,182, filed on Nov. 3, 2022.

(51) Int. Cl. H04L 41/147; H04L 43/0876; H04L 67/51; H04W 48/20

(52) U.S. Cl. CPC H04L 41/147; H04L 43/0876; H04L 67/51; H04W 48/20

(57) ABSTRACT

Methods, devices, and systems for analytics-enhanced edge enabling layer service continuity are described herein. In one aspect, a method can include receiving, by an analytics service, an analytics request from an Edge Enabling Layer (EEL) entity to perform Application Context Relocation (ACR) detection; collecting, by the analytics service, analytics information related to the detection of ACR; generating, by the analytics service, an ACR detection notification according to the collected analytics information; and sending, by the analytics service, the ACR detection notification to one or more reporting targets.

### CROSS-REFERENCE TO RELATED APPLICATIONS

This application claims the benefit of U.S. Provisional Patent Application No. 63/382,182, filed Nov. 3, 2022, which is hereby incorporated by reference in its entirety.

### BACKGROUND

FIG. 1 depicts the Edge Application Enabler Layer (EEL) architecture defined by the 3GPP SA6 working group. EEL refers to the overall functionality provided by the entities such as Edge Enabler Clients (EECs), Edge Enabler Servers (EESs) and Edge Configuration Servers (ECSs), necessary for enabling UE Application Clients (ACs) to interact with Edge Application Servers (EASs) over 3GPP networks. For edge computing, it is essential that UE ACs are able to locate and connect with the most suitable EASs available within the Edge Data Networks (EDNs) that the UEs are located in. This is dependent on the needs of the ACs and the availability of EASs in edge data networks. The EEL supports a set of services and exposes these services via APIs defined for each of the EEL defined reference points (e.g., EDGE-1 thru EDGE-9).

Some of these supported services include: services for discovery of ECSs and provisioning of edge computing services based on a UEs location and service requirements; services for registration of EECs to EESs and EASs to EESs; services for providing continuity of service between ACs and EASs (e.g., when a UE moves from one EDN to another EDN); and exposure of 5GC services for use by EASs.

The EEL can provide features that support service continuity for ACs in the UE to minimize service interruption while replacing the S-EAS with a T-EAS. The following scenarios are supported for service continuity: UE mobility, including predictive or expected UE mobility: overload situations in S-EAS or EDN; and maintenance aspects such as graceful shutdown of an EAS.

To support the need of ACR, following entity roles are identified: detection entity, detecting or predicting the need of ACR; decision-making entity, deciding that the ACR is required; and execution entity, executing ACR.

The EEL can further provide the feature of service continuity planning to support seamless service continuity, when information about planned, projected, or anticipated movement of the UE outside the service area of the serving EAS is available at the EEL.

Depending on whether the EEC is involved in the decision phase, whether the T-EAS discovery is performed by the EEC or S-EES, how the ACR request is sent and how the application context is transferred, the following scenarios have been identified: initiation of ACR by EEC using regular EAS discovery; EEC executed ACR via S-EES; S-EAS decided ACR scenario: S-EES executed ACR and EEC executed ACR via T-EES.

The current EEL relies on the information provided by the EEC/AC to perform service continuity planning. The EEC/AC can provide information about planned or predicted UE mobility behavior (whether a UE moves to the expected/predicted location) and detection of change of expected/predicted UE mobility, while the EES may monitor whether the UE has moved to the predicted/expected location. The planning only applies to the mobility-based service continuity scenario, while the non-mobility-based service continuity planning (e.g., predicted workload on an EAS) has not been defined.

The EEL can utilize analytics service (e.g., ADAES) to trigger EEL operations. For example, the EES can subscribe to edge load analytics and receive predictions of EAS/EDN load. Based on the received analytics information, the EES or EAS can generate a trigger event and the corresponding action, such as ACR detection. Since the analytics services are capable of consolidating various analytics information of the network and generate more insights based on the analytics data, it would be more beneficial for the EEL to have the analytics service act as an ACR detection entity and provide advanced analytics support for EEL service continuity. However, this feature is not supported in the current EEL.

Dynamic EAS instantiation is a feature offered by the EEL, which can be triggered by the EES due to service discovery request, UE mobility, upon receiving EEC registration request containing AC profile, etc. In the current EEL, dynamic EAS instantiation will be triggered when the EES fails to discover and select the EAS that matches the UE location and the requesting application characteristics due to no EAS being available or instantiated. However, triggering the EAS instantiation after receiving the request, and indicating the need for the EAS, may lead to delay or even interruption of service to the AC. The current EEL lacks the capability to support proactive EAS instantiation, which may leverage the predictive information provided by the analytics service to perform EAS instantiation proactively.

In some use cases such as real-time communication or multi-user session, multiple ACs may need to use services from a single common EAS to meet the latency requirements and to avoid the need for inter-EAS synchronization. In the current EEL, the selection of the common EAS is based on the information of the ACs that will be receiving service from the common EAS and the EDN. However, the EEL lacks the capability to provide a predictive selection of the common EAS based on analytics information.

### SUMMARY

The disclosure provided herein proposes enhancements to the service continuity procedure in an edge enabler layer by utilizing analytics services available at the service enabling layer, such as ADAES. The proposed analytics-enhanced service continuity functionality can include an analytics service (ADAES server/client) that can receive an analytics request from an EEL entity to perform ACR detection and provide suggestion/recommendation of T-EES and/or T-EAS. In some cases, the request specifies the trigger event for ACR detection. In some cases, the request specifies when and how the analytics service should send the notification for ACR detection, to which entity the analytics service should report the ACR detection, what analytics information should be provided by the analytics service in the notification. The analytics service can collect and generate analytics information related to the detection of ACR. The analytics service can receive a candidate list, from which the analytics service may make selections/evaluations for suggested T-EES and/or T-EAS of the ACR. In some cases, the candidate list may be received in the analytics request. In some cases, the candidate list may be retrieved from a list of entities, where the list of entities is specified in the analytics request. In some cases, the candidate list may be received before or after the ACR detection notification is sent.

The analytics service can send an ACR detection notification to the reporting targets. In some cases, the notification includes the predicted event time. In some cases, the notification may include suggested T-EES and/or T-EAS. In some cases, the notification may indicate a T-EAS as the common EAS for multiple ACs. The analytics service can send a proactive EAS instantiation notification to the predicted T-EES to trigger the instantiation of the predicted T-EAS. In some cases, the EAS instantiation notification and the corresponding ACR detection notification are generated jointly.

The proposed analytics-enhanced service continuity functionality can include an EEL entity (EEC/EES/EAS) that can send an analytics request to an analytics service. In some cases, the request can specify the trigger event for ACR detection. In some cases, the request specifies when and how the analytics service should send the notification for ACR detection, to which entity the analytics service should report the ACR detection, what analytics information should be provided by the analytics service in the notification.

The EEL entity can provide a candidate list to the analytics service, from which the analytics service may make selections/evaluations for suggested T-EES and/or T-EAS of the ACR. In some cases, the candidate list may be included in the analytics request. In some cases, the candidate list may be provided by a list of entities other than the ACR decision entity, where the list of entities is specified in the analytics request. In some cases, the candidate list may be provided before or after the ACR detection notification is sent.

The EEL entity can receive an ACR detection notification from the analytics service. The EEL entity can send a notification to the analytics service after making an ACR decision.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

FIG. 1 depicts an EEL architecture.

FIG. 2 depicts an overview of analytics-enhanced ACR.

FIG. 3 depicts ACR analytics subscription request and response.

FIG. 4 depicts EEC decided ACR with analytics support.

FIG. 5 depicts S-EAS or S-EES decided ACR with analytics support.

FIG. 6 depicts ACR update/modification with analytics support.

FIG. 7 depicts Analytics-assisted proactive EAS instantiation.

FIG. 8 depicts analytics-assisted common EAS selection.

FIG. 9 depicts an example graphical user interface (GUI) for analytics service configuration.

FIG. 10A depicts an example communications system in which the methods and apparatuses described and claimed herein may be an aspect of;

FIG. 10B depicts a block diagram of an example apparatus or device configured for wireless communications;

FIG. 10C depicts a system diagram of an example radio access network (RAN) and core network;

FIG. 10D depicts a system diagram of another example RAN and core network;

FIG. 10E depicts a system diagram of another example RAN and core network;

FIG. 10F depicts a block diagram of an example computing system; and

FIG. 10G depicts a block diagram of another example communications system.

### DETAILED DESCRIPTION OF ILLUSTRATIVE EMBODIMENTS

The edge enabling layer provides service continuity support for UEs when different EAS(s) become more suitable for serving the ACs in the UE, due to UE mobility, overloading of EAS or EDN, maintenance of EAS or EES, or other dynamics in the edge network. To support service continuity, the application context associated with the AC and EEC context associated with the EEC will be transferred from the S-EAS to a T-EAS. In the ACR process, the need of ACR will be detected or predicted by a detection entity, and the decision that the ACR is required is made by a decision-making entity, followed by the execution of ACR.

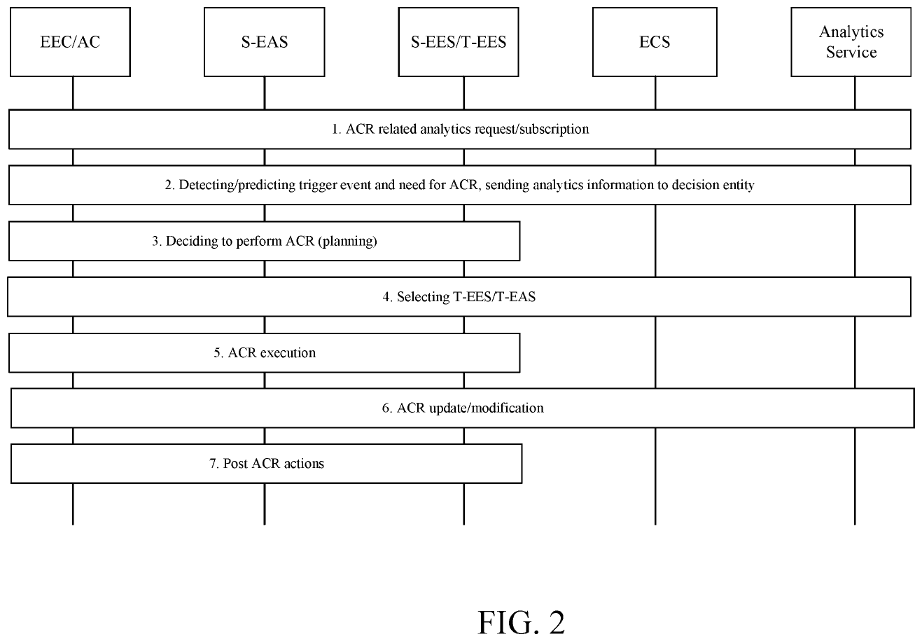

Analytics service (e.g., ADAES. NWDAF) can be leveraged by the edge enabling layer to enhance the ACR process by providing assistance in different phases of ACR. A high-level overview of analytics enhanced ACR is shown in FIG. 2.

Step 1: An EEL entity sends a request to the analytics service to request assistance with the ACR process. For example, an EEC/AC, S-EAS or S-EES may send an ACR analytics subscription request to the analytics service for predictive information of the edge network and/or events that may trigger ACR. The requesting entity may also request for recommendations or evaluations of T-EES or T-EAS, which can be generated by the analytics service based on the predictive information. In addition, the requesting entity may provide a list of candidate EESs/EASs, based on which the analytics service could make the recommendation or generate rankings of the candidates.

The analytics subscription request can be sent to analytics services in different layers for different types of ACR triggers. For example, two separate requests can be generated with one request for mobility based ACRs and another request for non-mobility based ACRs. Alternatively, a single analytics subscription request can be sent to the analytics service where the analytics service will generate/redirect the request(s) for other analytics services (e.g., NWDAF). The requestor may also incorporate data that can be utilized by the analytics service in the request, such as information of the requestor, application layer context information, etc.

Step 2: Based on the analytics subscription request, the analytics service may collect data from the edge network(s) and generate analytics results, such as the prediction of an ACR trigger event. The generated analytics results can be sent to the ACR detection and/or decision entity. The analytics service may provide analytics information to a detection entity to detect the need for ACR. Alternatively, the analytics service may detect/predict the need of ACR by itself and directly send the detection result to the decision entity. The analytics service may detect the trigger event before it happens based on data or predictive information the analytics service collects or receives from functions and services of the network, which enables proactive ACR operations and service continuity planning. The recommendation or evaluations of T-EES or T-EAS can be sent along with the analytics/detection result.

Step 3: After receiving the analytics for ACR detection, the ACR decision entity determines that ACR is required and may instruct the execution of ACR. The decision entity could be an EEC/AC (e.g., in the scenarios of initiation by EEC using regular EAS discovery, EEC executed ACR via S-EES, EEC executed ACR via T-EES), S-EAS (e.g., in the scenario of S-EAS decided ACR), or S-EES (e.g. in the scenario of S-EES executed ACR). Particularly, the edge enabling layer may decide to perform service continuity planning and proactive actions based on the predictive information provided by the analytics service.

Step 4: The decision entity may identify the T-EES and T-EAS with assistance from the analytics service. The recommended EES/EAS may be selected as the T-EES/T-EAS if such information has been provided by the analytics service in step 2. Otherwise, the decision entity may perform service provisioning and discovery procedure to identify the T-EES and T-EAS, during which the analytics service could provide supporting information and/or apply analytics results to help with the selection.

Step 5: After identifying the T-EES and T-EAS, the ACR procedure may be executed, such as relocating EEC context from the S-EES to the T-EES, transferring application context between the S-EAS and T-EAS, etc.

Step 6: After providing the detection of trigger event, the analytics service may continue providing updated information to the decision entity or other entities involved in the ACR and assist the ACR update/modification process (as requested in the original request in step 1 or after receiving an updated request). The analytics service may notify the decision entity of a change of the expected/predicted information, based on which an ACR update decision can be made. If the T-EES and/or T-EAS also need to change due to the update, the analytics service can provide updated recommendations/evaluations to assist the re-selection of T-EES/T-EAS.

Step 7: The edge enabling layer performs post ACR actions to complete and clean up the ACR process.

### ACR Analytics Subscription Request

An ACR analytics subscription request is an analytics service request that is specific to service continuity (ACR) type of analytics provided to the edge enabling layer.

The request can be initiated by an EEL entity or an application layer entity for service continuity (ACR) support, such as an EEC, EES, ECS, or EAS. For example, an EEC may initiate an ACR analytics subscription request after it registers to a new EES or when a new session is established between the associated AC and an EAS (e.g., the AC connects to a new EAS). An EES (S-EES) may initiate an ACR analytics subscription request when it receives a registration request from an EEC or EAS that requires service continuity support. An EAS may initiate an ACR analytics subscription request after it registers to an EES or connects to a new AC. An ECS may initiate an ACR analytics subscription request so that the analytics service may proactively monitor the status of the EDNs and collect analytics data.

The requestor may request the analytics service to provide predictive information (e.g., the predicted workload schedule and busiest times for an EAS), based on which the requestor may perform ACR detection by itself. Alternatively, the requestor may offload the ACR detection to the analytics service by specifying the trigger event to be detected (e.g., EAS KPIs dropping below defined thresholds), so that the analytics service may make proactive detection based on the generated analytics results and inform the decision entity. The analytics results will be sent to the detection entity and/or the decision entity to initiate the ACR process. For example, an EEC may request the analytics service to provide prediction of the workload of the S-EES that is currently serving the EEC and also provide workload of nearby EESs that can serve the EEC. An EEC may further request the analytics service to detect potential overloading of the S-EES and notify the EEC when the S-EES is predicted to be overloaded at a future time. Based on the received information/notification, the EEC may then make a decision to initiate or plan for an ACR. The requestor may specify more than one trigger events that are to be detected by the analytics service.

In addition to detection events, the requestor may also request the analytics service to provide recommendation of T-EES/T-EAS or evaluate the suitability of one or more EESs/EASs as the T-EES/T-EAS based on the predicted information and analytics results. The requestor may provide a list of candidates to the analytics service, among which the analytics service may select the recommended entity or provide a ranking. For example, the requesting EEC may include a list of EESs (which may be the list of EESs in the service provisioning response received by the EEC) as candidate T-EESs in the analytics request and specify predicted workload as the ranking criteria. The analytics service may then generate predictions and respond to the EEC with a ranking list of these EESs according to their predicted workload. The list of candidates can also be provided by other relevant entities to the analytics service or retrieved by the analytics service. For example, the EEC on a UE with mobility may request for analytics service but may not have information of EESs serving the target location. In this case, the analytics service may query the ECS to get the list of EESs that are serving the target location as candidate list (the target location could also be predicted by the analytics service).

The requestor may specify a reporting target other than itself to receive analytics notifications and results. In this case, the requestor may notify the reporting target before or after sending the ACR analytics subscription request. For example, a S-EES may initiate an ACR analytics subscription request on behalf of an EEC that is requesting service continuity support. The EEC will then be able to receive ACR related information (such as ACR detection notification and recommended T-EESs) and determine if/how to perform the ACR. Similarly, an EEC may make a ACR analytics subscription request on behalf of an AC, or an EES may make an ACR analytics subscription request on behalf of an EAS.

The requestor may instruct the analytics service to send a notification to the predicted/recommended T-EES and/or n-EAS. For example, the requestor may ask the analytics service to select a T-EES based on the analytics information. When a trigger event is detected, the analytics service may select a suggested T-EES and notify both the requestor and the selected T-EES. The T-EES may then perform proactive actions to prepare for the ACR process, such as reserving resources, dynamic EAS instantiation, etc.

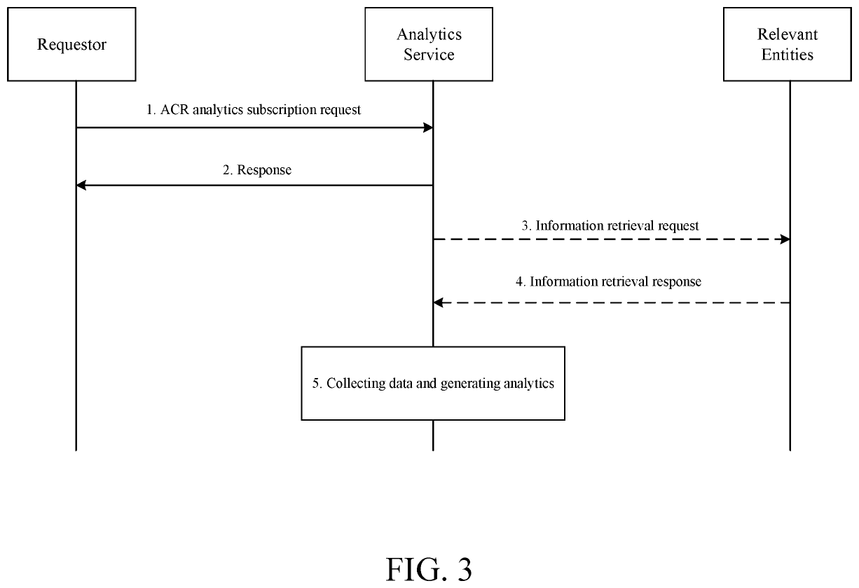

The procedure for initiating an ACR analytics subscription request is shown in FIG. 3.

Step 1: The requestor sends an ACR analytics subscription request to the analytics service for analytics assistance of an ACR procedure. The request may include information shown in Table 1.

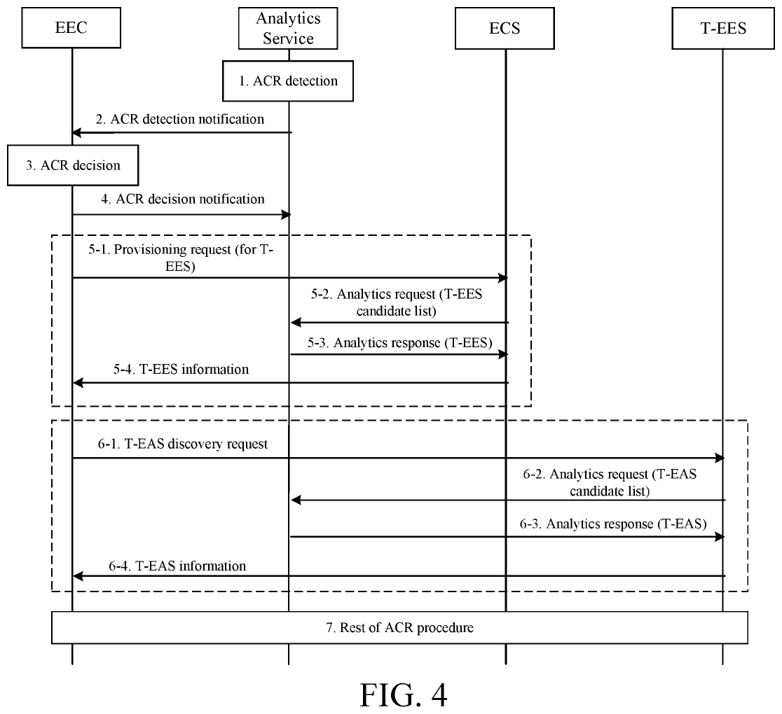

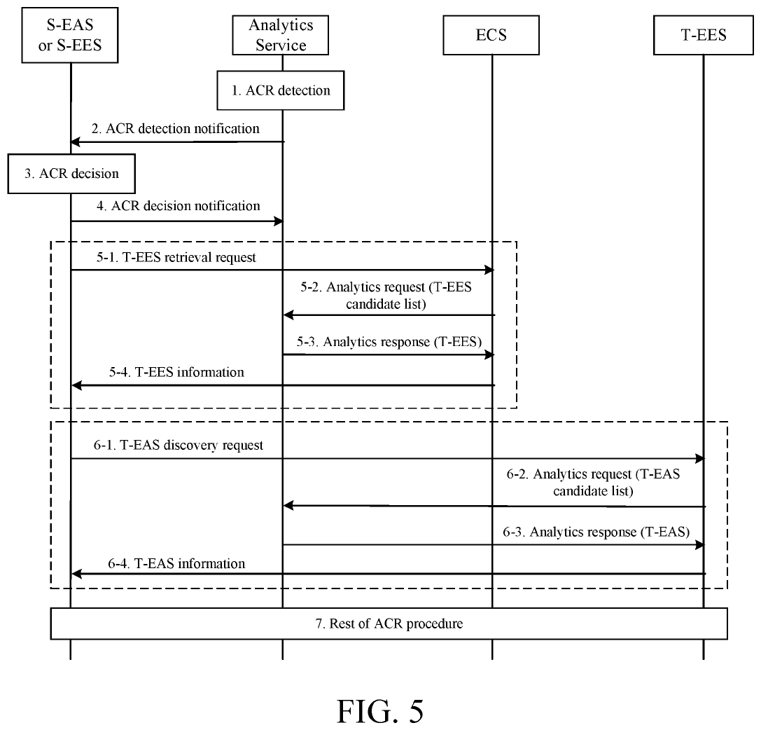

TABLE 1
ACR analytics subscription request

| Information Element | Description |
|---|---|
| ACR analytics | Identifier of the ACR analytics subscription to be created for this |
| subscription identifier | request. This information element will be used throughout the analytics |
| | enhanced ACR process by both the EEL and the analytics service to |
| | associate different information and entities with this ACR process. |
| | The ACR analytics subscription can also be defined/identified as a |
| | combination of identifiers of the corresponding AC, EEC, UE, S-EES |
| | and/or S-EAS. |
| Common settings | Common settings for an analytics request that are not specific to ACR |
| | process, such as analytics targets, requirements, analytics period, |
| | desired output (e.g., statistics, prediction, recommendation, rank list), |
| | etc. |
| Detection events | Specifies the ACR triggering event that is to be predicted and detected |
| | by the analytics service based on the analytics information. Any |
| | condition or threshold associated with the trigger event may also be |
| | specified. The requestor may specify multiple types of events in this |
| | information element, or generate a separate ACR analytics subscription |
| | request for each type of detection event. |
| | For example, a detection event could be an EAS or EES is predicted to |
| | be overloaded, an EES is expected to be shut down for maintenance, the |
| | number of active sessions in an EDN is predicted to exceed a threshold, |
| | etc. Note that the threshold could be defined as a variable value which |
| | is determined based on the analytics results. |
| Reporting targets | Specifies one or more target entities to which the analytics service |
| | should report the detection event. For example, the decision entity in an |
| | ACR (EEC, S-EAS, S-EES) can be specified as the reporting target. |
| | The reporting target could be the same as the requestor. |
| | This information element can also be configured so that the analytics |
| | service will determine the reporting target based on the analytics |
| | results. For example, the reporting target can be specified as the |
| | suggested T-EES which can be identified by the analytics service. The |
| | reporting target can also be specified as the corresponding decision |
| | entity of the ACR scenario, where the ACR scenario is to be |
| | determined by the analytics service. |
| Notification settings | Configures when/how the ACR detection notification should be sent to |
| | the reporting target, and what information should be included in the |
| | notification (see Table for a list of information that could be included |
| | in the notification). |
| | The requestor may specify that the notification should be sent |
| | immediately when the analytics result indicating the trigger event is |
| | generated, or the notification should be sent at a given period of time |
| | ahead of when the event is expected to happen. |
| | The requestor may also specify what analytics information is required |
| | from the analytics service when sending the notification, such as |
| | suggested/recommended T-EES and/or T-EAS, rankings (in the format |
| | of an ordered list) of candidates in the candidate list in terms of |
| | predicted workload or performance, suggesting of ACR scenario, etc. |
| Candidate list | A list of identifiers of the candidate entities in the ACR, based on |
| | which the analytics service may make selection or recommendations of |
| | T-EES or T-EAS and send to the reporting target. For example, a list of |
| | EESs may be specified as candidates and the analytics service may |
| | choose/recommend one or more EESs from the candidate list as T- |
| | EES(s). |
| | The candidate list can be the same as the analytics targets. |
| | If the requestor is not able to specify the candidate list at the time of |
| | sending the ACR analytics subscription request, the requestor may |
| | include an indicator instructing the analytics service to retrieve |
| | information from other relevant entities (as specified in the relevant |
| | entity list). The candidate list can also be filled out after the ACR is |
| | initiated, when the analytics service receives the information from |
| | relevant entities. |
| Relevant entity list | A list of identifiers of the entities from which the analytics service may |
| | receive/retrieve the candidate list and/or other information necessary for |
| | the ACR analytics, such as the ECS, S-EES, S-EAS, nearby EESs that |
| | can serve the EEC, etc. |
| | The requestor may also include necessary authorizations (e.g., the |
| | requestor's identifier or authorization token) for the analytics service to |
| | access the relevant entities in this list. |
| | The requestor may specify whether the analytics service should actively |
| | retrieve information from the relevant entities (step 3 of FIG. 3 or wait |
| | for a request from the relevant entities (step 5-2 or step 6-2 of FIG. 4 or |
| | FIG. 5). |
| Continuous analytics | An indicator of whether the analytics service should continue providing |
| indicator | analytics results of this ACR analytics subscription after the trigger |
| | event is detected and a notification is sent. This information element |
| | may be used to request updated analytics information to trigger ACR |
| | update/modification before the ACR is executed. |
| | For example, after sending the ACR detection notification based on the |
| | initial analytics results, the analytics service may continue to collect |
| | analytics data to derive more accurate analytics results and send |
| | updated results to the reporting target. |
| | Alternatively, the requestor may send an updated request to the |
| | analytics service to request for continuous analytics. |

The requestor may also incorporate data that can be utilized by the analytics service in the request, such as information of the requesting entity (e.g., EEC and the corresponding AC), application layer context information, etc.

Step 2: The analytics service processes the request and sends a response back to the requestor. The analytics service may create an analytics subscription for this request.

Step 3: If the candidate list has not been specified in the request or additional information is needed, the analytics service may send a request to the relevant entities (as specified in the relevant entity list) to obtain information of the candidates. The request may include identifier of the ACR analytics subscription or other identifiers (e.g., identifier of the ACR analytics subscription requester such as identifier of an EEC, EES, EAS) and authorizations (e.g., the requestor's identifier or authorization token) provided by the ACR analytics requestor. For example, the analytics service may send a request to the ECS to retrieve a list of EESs that can serve as the T-EES for this ACR with the analytics subscription identifier and an EEC identifier.

Note that this step may be performed after analytics results are generated (step 5). For example, the analytics service may determine the suggested T-EES based on the analytics results, and send a request to the determined T-EES to retrieve/discover information of the EASs that can serve as the T-EAS for this ACR.

Step 4: The information of the candidate entities is sent to the analytics service.

Step 5: The analytics service starts collecting data and generating analytics results to detect the ACR trigger event and/or fulfil other requirements indicated in the analytics request. For example, if the ACR detection event is defined as the predicted workload of a certain EES exceeding a threshold, the analytics service will keep generating/updating prediction of the EES's workload and comparing the predicted value with the threshold. The analytics service may also generate workloads of nearby EESs to use for comparison and to assist with the prediction or analytics output. Note the analytics service may selectively perform the comparison when necessary, e.g., when the current EES's workload is close to or exceeds the threshold value. The analytics service may also collect application specific context (e.g., user's schedule defined in an application, calendar event for a meeting) to generate predictions.

### Analytics-Assisted ACR

The analytics service may assist the ACR process with the detection of trigger events, selection of the T-EES and/or T-EAS, and the update or modification of ACR.

In the analytics-assisted EEC/AC decided ACR scenario, the ACR detection notification is sent to the EEC so that the EEC makes the ACR decision. Additionally, the EEC may initiate the discovery of T-EES and T-EAS. The EEC/AC decided ACR applies to the following scenarios: initiation by EEC using regular EAS discovery; EEC executed ACR via S-EES; and EEC executed ACR via T-EES.

In analytics-assisted EEC/AC decided ACR, the EEC will be interacting with the analytics service (directly or indirectly via the S-EES) to get analytics support, as shown in FIG. 4.

Step 1: The EEC performs an ACR analytics subscription request as shown in FIG. 3 to obtain assistance from the analytics service in detecting ACR events. The analytics service detects that the detection event defined in the ACR analytics subscription request is expected to happen at a future time based on the generated analytics information. For example, when the analytics service generates a workload prediction that exceeds the threshold, the ACR event is detected.

Step 2: According to the requirements defined in the notification setting in the ACR analytics subscription request, the analytics service sends an ACR detection notification to the EEC. The notification may include information specified in Table 2. The notification may include suggested T-EES and/or T-EAS for the ACR. Steps 1 and 2 may serve as the ACR detection phase in service continuity procedure.

TABLE 2
ACR detection notification

| Information Element | Description |
|---|---|
| ACR analytics | Identifier of the ACR analytics subscription. |
| subscription identifier | |
| ACR analytics requestor | Identifier of the requestor that initiates the ACR analytics subscription |
| identifier | request. This information element can be omitted if the EEC is the |
| | requestor. |
| Event description | A description of the detection event. If more than one type of detection |
| | event has been defined in the ACR analytics subscription request, this |
| | information element may specify which event triggered this |
| | notification. |
| Event time | The predicted time or period when the detection event will happen. If |
| | the exact event time cannot be provided at the time of sending this |
| | notification, an earliest and/or latest predicted event time can be |
| | provided. |
| Relocation targets | One or more suggested T-EESs and/or T-EASs, or a list of ranked T- |
| | EESs and/or T-EASs, which are generated according to the |
| | requirements defined in the ACR analytics subscription request. |
| Analytics results | Analytics results that are generated according to the requirements |
| | defined in the ACR analytics subscription request. |
| Partial notification | An indicator of whether the notification message contains all the |
| indicator | information that can be provided by the analytics service or it is only |
| | partial information. This information element may indicate one or more |
| | follow-up notification messages will be sent by the analytics service |
| | with further information. |

The ACR detection notification may be sent in multiple messages at different times. In this case, the analytics service may use the partial notification indicator in the notification message to indicate that further information will be provided in later notification messages.

For example, the analytics service may send a first notification when analytics results indicating the detection event are generated, where the notification may not contain the event time or suggested T-EES. After enough analytics information has been collected or generated to derive the event time and T-EES suggestion, a follow-up notification can be sent.

Step 3: The EEC or the corresponding AC makes the decision to perform or plan for the ACR based on the received notification.

Step 4: The EEC sends a notification to the analytics service indicating that an ACR decision has been made. The notification may include the identifier of the T-EES and T-EAS that are selected by the EEC (if applicable). This information can be used by the analytics service to update analytics information of the edge network (e.g., update the predicted workload of the S-EES/T-EES and S-EAS/T-EAS). In this notification, the EEC may instruct the analytics service whether it should continue providing updated analytics results of the ACR analytics subscription.

Step 5-1: If the suggested T-EES is required in the ACR analytics subscription request but has not been provided by the analytics service in the ACR detection notification(s) (e.g. due to lack of information of candidate list and/or relevant entity list, or the analytics service was unable to retrieve the information), the EEC performs service provisioning for the desired T-EES(s) by querying the ECS. In the service provisioning request, the EEC may specify that the request is associated with an analytics-enhanced ACR by including the analytics subscription identifier and/or the identifier of the analytics service in the provisioning request.

Step 5-2: After receiving the service provisioning request indicating analytics support, the ECS first generates a list of EESs according to the requirements in the provisioning request (e.g., AC profiles) as in a normal provisioning response. Then the list of EESs is sent to the analytics service to be filtered with analytics information.

Step 5-3: Upon receiving the list of EESs from the ECS, the analytics service identifies the corresponding ACR analytics subscription and updates the candidate T-EES list with the received list of EESs. Then the analytics service will generate suggestions/recommendations of T-EES according to the requirements in the ACR analytics subscription request. For example, if the request is to select the EES with lowest predicted workload at the event time, then the analytics service may compare the predicted workload of EESs in the list and make the selection. If the request is to rank the EESs in the candidate list according to their reliabilities, the analytics service may evaluate the reliability of each EES in the candidate list (e.g., based on the statistics of server downtime) and generate an ordered list. The suggested EES(s) or the ranked T-EES list will be sent back to the ECS or directly to the EEC.

Step 5-4: The ECS generates the service provisioning response with the analytics-processed EES list obtained in step 5-3 and sends the response to the EEC.

Step 6-1: If a suggested T-EAS is required in the ACR analytics subscription request but has not been provided by the analytics service in the ACR detection notification (e.g. due to lack of information of candidate list and/or relevant entity list, or the analytics service was unable to retrieve the information), the EEC performs EAS discovery for the desired T-EAS by querying the T-EES that was identified in step 2 or 5. In the discovery request, the EEC may specify that the request is associated with an analytics-enhanced ACR by including the analytics subscription identifier and/or the identifier of the analytics service in the discovery request.

Step 6-2: After receiving the T-EAS discovery request indicating analytics support, the T-EES first generates a list of EASs according to the filter criteria in the discovery request as in a normal discovery response. Then the list of EASs is sent to the analytics service to be filtered with analytics information.

Step 6-3: Upon receiving the list of EASs from the T-EES, the analytics service identifies the corresponding ACR analytics subscription and updates the candidate T-EAS list with the received list of EASs. Then the analytics service will generate suggestions/recommendations of T-EAS according to the requirements in the ACR analytics subscription request. The suggested EAS(s) or the ranked T-EAS list will be sent back to the T-EES or directly to the EEC.

Step 6-4: The T-EES generates the discovery response with the analytics-processed EAS list obtained in step 6-3 and sends the response to the EEC.

The analytics service may assist in making a joint selection of T-EES and T-EAS. In this case, the EEC may receive multiple suggested T-EESs and perform step 6-1 with each of the suggested T-EES. Then each suggested T-EES may perform step 6-2 and provide the analytics service with the corresponding EAS list. The analytics service may consolidate the EAS lists from multiple EESs that are associated with the same ACR analytics subscription and update the candidate list with pairs of T-EES and T-EAS. Then the analytics service will generate suggestions/recommendations of T-EES and T-EAS jointly according to the requirements in the ACR analytics subscription request. The suggested T-EES and T-EAS pair(s) will be sent back to the corresponding T-EES(s) or directly to the EEC.

Step 7: The rest of the ACR procedure will be performed with the identified T-EES and T-EAS. When generating the ACR request, the EEC may include information obtained from the analytics service, such as the predicted event time. After the entire ACR process is completed, the EEC may send a notification to the analytics service to update the ACR analytics subscription request or terminate the analytics subscription.

In the analytics-assisted S-EAS/S-EES decided ACR scenario, the ACR detection notification is sent to the S-EAS/S-EES to make the ACR decision. Additionally, the S-EAS/S-EES may initiate the discovery of T-EES and T-EAS. The S-EAS/S-EES decided ACR applies to the following scenarios: S-EAS decided ACR scenario; and S-EES executed ACR.

In analytics-assisted S-EAS/S-EES decided ACR, the S-EAS/S-EES will be interacting with the analytics service to get analytics support, as shown in FIG. 5.

Step 1: Same as step 1 of FIG. 4.

Step 2: Similar to step 2 of FIG. 4, the analytics service sends an ACR detection notification to the decision entity (S-EAS or S-EES). The notification may include information specified in Table 2. The notification may include suggested T-EES and/or T-EAS for the ACR. Steps 1 and 2 may serve as the ACR detection phase in service continuity procedure.

Step 3: The S-EAS or S-EES makes the decision to perform or plan for the ACR based on the received notification.

Step 4: The decision entity (S-EAS or S-EES) sends a notification to the analytics service indicating that an ACR decision has been made. This information can be used by the analytics service to update analytics information of the edge network (e.g., update the predicted workload of the S-EES/T-EES and S-EAS/T-EAS). In this notification, the decision entity may instruct the analytics service whether it should continue providing updated analytics results of the ACR analytics subscription.

Step 5-1: If a suggested T-EES is required in the ACR analytics subscription request but has not been provided by the analytics service in the ACR detection notification(s), the S-EAS/S-EES sends a request to retrieve T-EES information from the ECS. In the EES retrieval request, the S-EAS/S-EES may specify that the request is associated with an analytics-enhanced ACR by including the analytics subscription identifier and/or the identifier of the analytics service in the EES retrieval request.

Step 5-2: Same as step 5-2 of FIG. 4.

Step 5-3: Upon receiving the list of EESs from the ECS, the analytics service identifies the corresponding ACR analytics subscription and updates the candidate T-EES list with the received list of EESs. Then the analytics service will generate suggestions/recommendations of T-EES according to the requirements in the ACR analytics subscription request. The suggested EES(s) or the ranked T-EES list will be sent back to ECS or directly to the S-EAS/S-EES.

Step 5-4: The ECS generates the EES retrieval response with the analytics-processed EES list obtained in step 5-3 and sends the response to the S-EES. If the T-EES retrieval request was received from the S-EAS, the S-EES responds to the S-EAS with the discovered T-EES Information.

Step 6-1: If a suggested T-EAS is required in the ACR analytics subscription request but has not been provided by the analytics service in the ACR detection notification, the S-EAS/S-EES performs EAS discovery for the desired T-EAS by querying the T-EES that was identified in the previous step. In the discovery request, the S-EAS/S-EES may specify that the request is associated with an analytics-enhanced ACR by including the analytics subscription identifier and/or the identifier of the analytics service in the discovery request.

Step 6-2: Same as step 6-2 of FIG. 4.

Step 6-3: Upon receiving the list of EASs from the T-EES, the analytics service identifies the corresponding ACR analytics subscription and updates the candidate T-EAS list with the received list of EASs. Then the analytics service will generate suggestions/recommendations of T-EAS according to the requirements in the ACR analytics subscription request. The suggested EAS(s) or the ranked T-EAS list will be sent back to the T-EES or directly to the S-EAS/S-EES.

Step 6-4: The T-EES generates the discovery response with the analytics-processed EAS list obtained in step 6-3 and sends the response to the S-EES. If the discovery request was received from the S-EAS, the S-EES responds to the S-EAS with the discovered T-EAS Information.

The analytics service may assist in making a joint selection of T-EES and T-EAS. In this case, the S-EAS/S-EES may receive multiple suggested T-EESs and perform step 6-1 with each of the suggested T-EES. Then each suggested T-EES may perform step 6-2 and provide the analytics service with the corresponding EAS list. The analytics service may consolidate the EAS lists from multiple EESs that are associated with the same ACR analytics subscription and update the candidate list with pairs of T-EES and T-EAS. Then the analytics service will generate suggestions/recommendations of T-EES and T-EAS jointly according to the requirements in the ACR analytics subscription request. The suggested T-EES and T-EAS pair(s) will be sent back to the corresponding T-EES(s) or directly to the S-EAS/S-EES.

Step 7: The rest of the ACR procedure will be performed with the identified T-EES and T-EAS. After the entire ACR process is completed, the S-EAS/S-EES may send a notification to the analytics service to update the ACR analytics subscription request or terminate the analytics subscription.

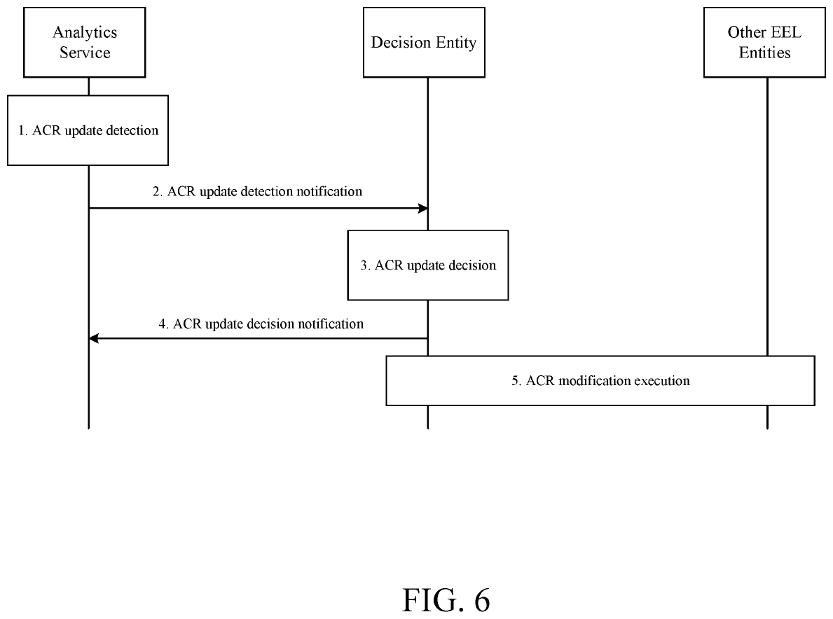

After the initial ACR detection notification containing prediction information is sent to the decision entity, the analytics service may continue to collect data of the analytics targets and generate updated analytics results (as required in the ACR analytics subscription request via the continuous analytics indicator), which may trigger an ACR status update/modification. For example, the suggested T-EES or the predicted time of event may change as the analytics results are being updated. In this case, the analytics service may send another notification to the corresponding EEC, EES or EAS to trigger an ACR update or modification procedure, as shown in FIG. 6.

Step 1: The analytics service detects a change of the expected detection event, such as a change of the predicted event time, change of recommended T-EES/T-EAS, etc.

Step 2: The analytics service sends an ACR update detection notification to the decision entity (EEC, S-EAS, or S-EES) according to the requirements defined in the notification setting in the ACR analytics subscription request. The notification may include updated information specified in Table 2, such as updated event time, updated relocation target, updated analytics results, etc.

Step 3: Based on the notification received in step 2, the decision entity identifies that one or more ACR updates/modifications are needed.

Step 4: The decision entity sends a notification to the analytics service indicating that an ACR update decision has been made. This information can be used by the analytics service to update analytics information of the edge network (e.g., update the predicted workload of the S-EES/T-EES and S-EAS/T-EAS). In this notification, the EEC may instruct the analytics service whether it should further continue providing updated analytics results of the ACR analytics subscription.

Step 5: The decision entity interacts with the other relevant EEL entities to execute the ACR modification procedure. After the ACR modification is executed, the decision entity may send a notification to the analytics service to update the ACR analytics subscription request.

The analytics service may be able to determine that using specific ACR scenarios is more beneficial (e.g., fewer notification and state changes in EEL.) based on various factors such as the AC service KPI, supported scenarios of relevant entities, coordination requirements, analytics information of the ACRs, etc. For example, in a specific deployment, the trend may indicate that EEC determined ACRs are best, then such ACR scenario may be determined. Depending on the determination, not only the ACR scenarios used may change, but some updates may be needed, such as the profiles indicating what scenarios are supported.

### Analytics-Assisted Proactive EAS Instantiation

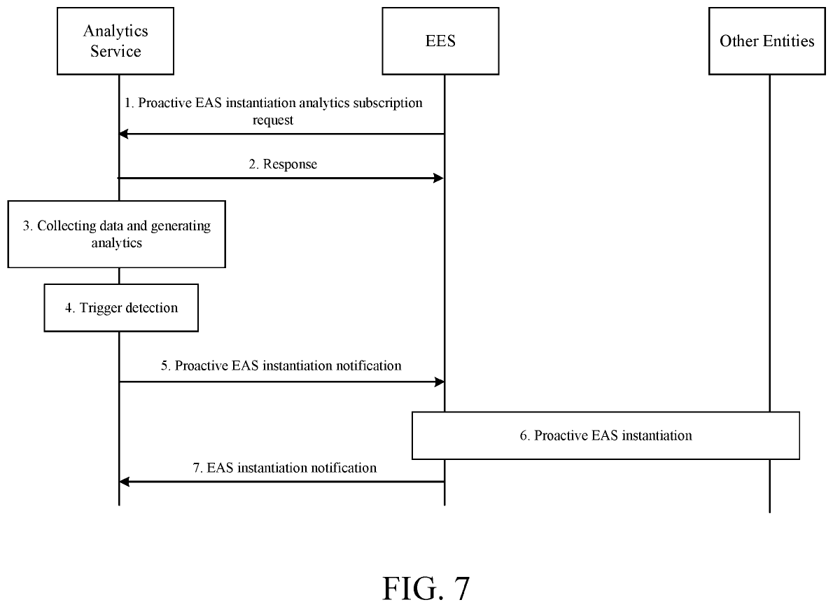

An EES may also initiate a proactive EAS instantiation analytics subscription request to get predictive event notification from the analytics service if it is expected to become a T-EES so that proactive actions can be taken in preparation for an upcoming ACR, such as dynamic EAS instantiation. In addition to service continuity (planning), analytics services can be applied in other scenarios where proactive EAS instantiation is beneficial, such as general scheduling and load balancing, EAS discovery, etc. FIG. 7 shows an exemplary procedure for analytics-assisted proactive EAS instantiation.

Step 1: The requesting EES sends a proactive EAS instantiation analytics subscription request to the analytics service for analytics assistance of proactive EAS instantiation. The request may include information shown in Table 3.

TABLE 3
Proactive EAS instantiation analytics subscription request

| Information Element | Description |
|---|---|
| Proactive EAS | Identifier of the analytics subscription that is to be created for this |
| instantiation analytics | request. |
| subscription identifier | |
| EAS identifier | Identifier(s) of the instantiable EAS. |
| | The EES may request analytics service for a single EAS in the request, |
| | or for multiple/all the EASs that have registered at the EES in a single |
| | request. |
| EES identifier | Identifier of the requesting EES. |
| Common setting s | Common settings for an analytics request that are not specific to EAS |
| | instantiation, such as analytics targets, requirements, analytics period, |
| | etc. |
| Trigger events | Specify the dynamic instantiation triggering event that is to be |
| | predicted and detected by the analytics service based on the analytics |
| | information. Any condition or threshold associated with the trigger |
| | event will also be specified. The requesting EES may specify multiple |
| | types of events in this information clement, or generate a separate |
| | analytics request for each type of detection event. |
| | For example, a detection event could be the EES is selected to be the T- |
| | EES of an upcoming ACR and the instantiable EAS is selected to be |
| | the T-EAS, an instantiated EAS of the same type is predicted to be |
| | overloaded, the number of ACs requiring the EAS is predicted to |
| | exceed a threshold, etc. Note that the threshold could be defined as a |
| | variable value which is determined based on the analytics results. |
| Reporting targets | Specify one or more target entities to which the analytics service should |
| | report the trigger event. The reporting target could be the same as the |
| | requesting EES. |
| Notification settings | Configures when/how the proactive EAS instantiation notification |
| | should be sent to the reporting target, and what information should be |
| | included in the notification (see Table for a list of information that |
| | could be included in the notification). |
| | The requestor may specify that the notification should be sent |
| | immediately when the analytics result indicating the trigger event is |
| | generated, or the notification should be sent at a given period of time |
| | ahead of when the event is expected to happen. |
| | The requestor may also specify what analytics information is required |
| | from the analytics service when sending the notification. |

Step 2: The analytics service processes the request and sends a response back to the requesting EES. The analytics service may create a proactive EAS instantiation analytics subscription for this request.

Step 3: The analytics service starts collecting data and generating analytics results to detect the trigger event. For example, if the trigger event is defined as the predicted number of ACs requiring this type of EAS exceeding threshold, the analytics service will keep generating/updating predictions of the number of ACs and comparing the predicted value with the threshold. If the trigger event is defined as the predicted workload of other EASs of the same type exceeding the threshold, the analytics service will keep generating/updating predictions of the EAS workload and comparing the predicted value with the threshold.

The analytics service may further associate different analytics subscriptions (requested by different entities) and generate/derive analytics jointly across these subscriptions if the analytics results from these subscriptions are relevant or dependent. For example, if the trigger event in a proactive EAS instantiation analytics subscription request is defined as the EAS being selected as T-EAS, the analytics service may identify the ACR analytics subscriptions whose candidate list may include this EAS. If an ACR analytics subscription results in suggesting this EAS as the T-EAS, the analytics service may generate the proactive EAS instantiation notification and send to the corresponding EES.

Step 4: The analytics service detects that the trigger event defined in the proactive EAS instantiation analytics subscription request is expected to happen at a future time based on the generated analytics information. For example, when the requesting EES and an instantiable EAS are selected as the T-EES and T-EAS of an upcoming ACR respectively, the trigger event is detected. When a workload prediction of an instantiated EAS exceeds the threshold, the proactive instantiation of an instantiable EAS of the same type could be triggered. When the expected number of ACs requiring a certain type of EAS exceeds the threshold, the proactive instantiation of an instantiable EAS of the same type could be triggered.

Step 5: According to the requirements defined in the notification setting in the proactive EAS instantiation analytics subscription request, the analytics service sends a proactive instantiation notification to the EES. The notification may include information specified in Table 4.

TABLE 4
Proactive EAS instantiation notification

| Information Element | Description |
|---|---|
| Proactive EAS | Identifier of the proactive EAS instantiation analytics subscription. |
| instantiation analytics | |
| subscription identifier | |
| Proactive instantiation | An identifier of the EAS that is to be proactively instantiated. |
| EAS identifier | |
| Event description | A description of the trigger event. If more than one type of trigger event |
| | has been defined in the proactive EAS instantiation analytics |
| | subscription request, this information element may specify which event |
| | triggered this notification. |
| Event time | The predicted time or period when the trigger event will happen. If the |
| | exact event time cannot be provided at the time of sending this |
| | notification, an earliest and/or latest predicted event time can be |
| | provided. |
| Analytics result | Analytics results that are generated according to the requirements |
| | defined in the proactive EAS instantiation analytics subscription |
| | request. |
| Partial notification | An indicator of whether the notification message contains all the |
| indicator | information that can be provided by the analytics service or it is only |
| | partial information. This information element may indicate one or more |
| | follow-up notification messages will be sent by the analytics service |
| | with further information. |

The proactive EAS instantiation notification may be sent in multiple messages at different times. In this case, the analytics service may use the partial notification indicator in the notification message to indicate that further information will be provided in later notification messages. For example, the analytics service may send a first notification when analytics results indicating the trigger event are generated, where the notification may not contain the event time. After enough analytics information has been collected or generated to derive the event time, a follow-up notification can be sent.

Step 6: The EES makes the decision to perform dynamic EAS instantiation based on the received notification.

Step 7: The EES may send a notification to the analytics service indicating that one or more proactive EAS instantiations have been performed. This information can be used by the analytics service to update analytics information of the corresponding EAS(s) and the edge network.

### Analytics-Assisted Common EAS Selection

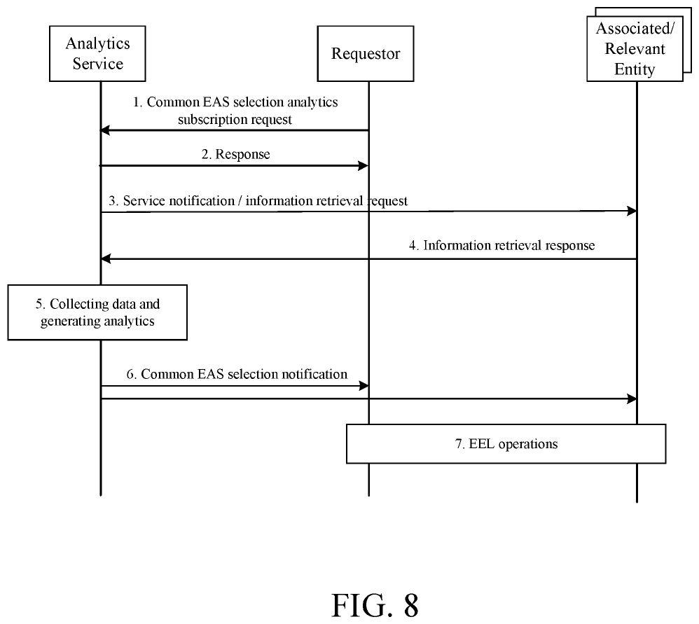

For use cases involving real-time communication in a multi-user session, both between AC and EAS and between different ACs via the EAS, it may be necessary or beneficial to use services from a single common EAS to meet the latency requirements and to avoid the need for inter-EAS synchronization. The analytics service may assist the selection of the common EAS and provide trigger detection to help coordinate EEL operations for such scenarios. FIG. 8 shows an exemplary procedure for analytics-assisted common EAS selection.

Step 1: The requestor sends a common EAS selection analytics subscription request to the analytics service for assistance of selecting a common EAS. The requestor could be one of the ACs that will be receiving service from the common EAS, or the EEC/EES/ECS that is associated with one or more of the ACs that will be receiving service from the common EAS. The request may include information shown in Table 5.

TABLE 5
Common EAS selection analytics subscription request

| Information Element | Description |
|---|---|
| AC information | Provide information of the ACs (and other relevant entities associated |
| | with the ACs) that will be receiving service from the common EAS. |
| | Information of the EAS(s) that is currently serving the ACs may also be |
| | included. |
| Common settings | Common settings for an analytics request that are not specific to |
| | common EAS selection, such as analytics targets, requirements, |
| | analytics period, etc. |
| Selection criteria | Define the criteria for selecting the common EAS, such as |
| | average/predicted workload, average/predicted KPI, (predicted) KPI |
| | variance of each session between an AC and the common EAS, etc. |
| Reporting targets | Specify one or more target entities to which the analytics service should |
| | send the notification or report the analytics information. The reporting |
| | target could be the same as the requestor, or the ACs (or the |
| | corresponding EECs) that will be receiving service from the common |
| | EAS. |
| Notification settings | Configures what analytics information should be included in the |
| | notification., such as the identifier of the selected common EAS, |
| | analytics information of the current serving EAS(s) and the selected |
| | common EAS, etc. |
| | The requestor may include an indicator of whether the analytics service |
| | should send an ACR trigger in the notification when the selected |
| | common EAS is different from the EAS that is currently serving the |
| | AC(s). |
| Candidate list | A list of identifiers of the candidate EASs, from which the common |
| | EAS can be selected. The information of the EES(s) where the |
| | candidate EASs could be instantiated can also be included. |
| | If the requestor is not able to specify the candidate list at the time of |
| | sending the analytics request, the requestor may include an indicator |
| | instructing the analytics service to retrieve information from other |
| | relevant entities (as specified in the relevant entity list). |
| Relevant entity list | A list of identifiers of the entities from which the analytics service may |
| | receive/retrieve the candidate list and/or other information necessary |
| | for the common EAS selection, such as the ECS, EES(s), etc. |
| | The requestor may also include necessary authorizations (e.g., the |
| | requestor's identifier or authorization token) for the analytics service to |
| | access the relevant entities in this list. |

Step 2: The analytics service processes the request and sends a response back to the requestor.

Step 3: The analytics service may send a notification to the ACs and/or other EEL entities that are associated with the ACs (e.g., EECs, EESs, ECS) for which the common EAS is to be selected. The notification may indicate that a common EAS selection analytics subscription has been created. The analytics service may also send an information retrieval request to the relevant entities as specified in the analytics subscription request to obtain information in Table 5 if such information has not been provided in step 1.

Step 4: Additional information is provided by the relevant entities to the analytics service as requested in step 3.

Step 5: The analytics service starts collecting data and generating analytics results to make the common EAS selection. The analytics may be collected or generated based on the information of the ACs that will be receiving service from the common EAS and the common EAS will be determined based on the selection criteria.

The analytics service may identify ACs that may benefit from the common EAS selection but are currently receiving services from different EASs (e.g., due to their locations). The analytics service may generate predictive location/path information for each AC and/or predictive information of the network, EAS loads, QoS of the links/sessions. Based on the collected/generated analytics, the analytics service may identify the common EAS (which may be different from any of the EASs that are currently serving the ACs) and suggest the ACs to connect to the common EAS (via ACR). For example, UAV/V2X applications may define margins in their paths/destinations in which the paths can be adjusted so that the associated ACs may receive service from a common EAS. The analytics service may help select the common EAS for such applications by considering their paths/destinations with the margins.

The analytics service may associate different analytics subscriptions and generate/derive analytics jointly. For example, if the analytics service is also functioning as an ACR detection entity and responsible for predicting the need of an ACR operation, it may take into consideration the result of common EAS selection and trigger an ACR detection notification if the selected EAS is different from the one that is currently serving the AC. In another example, if the common EAS currently being used by the ACs is predicted to be overloaded, the analytics service may share the predictions (ACR detection notification) in a coordinated manner with each of the AC/EECs being affected. If the selected common EAS is one of the instantiable EAS in a proactive EAS instantiation analytics subscription, the analytics service may generate a proactive EAS instantiation notification to the corresponding EES.

Step 6: The analytics service sends a notification to the reporting targets with the information of the selected common EAS and other information as required in the analytics subscription request. If the common EAS selection request is associated with other analytics subscriptions, the selection of EAS may trigger other notifications such as an ACR detection notification or a proactive EAS instantiation notification, in which case the analytics service may consolidate the notification messages and send to the corresponding entity.

Step 7: The EEL entities may perform operations based on the received analytics result of common EAS, such as to perform/plan ACR or trigger EAS instantiation.

### Graphical User Interface

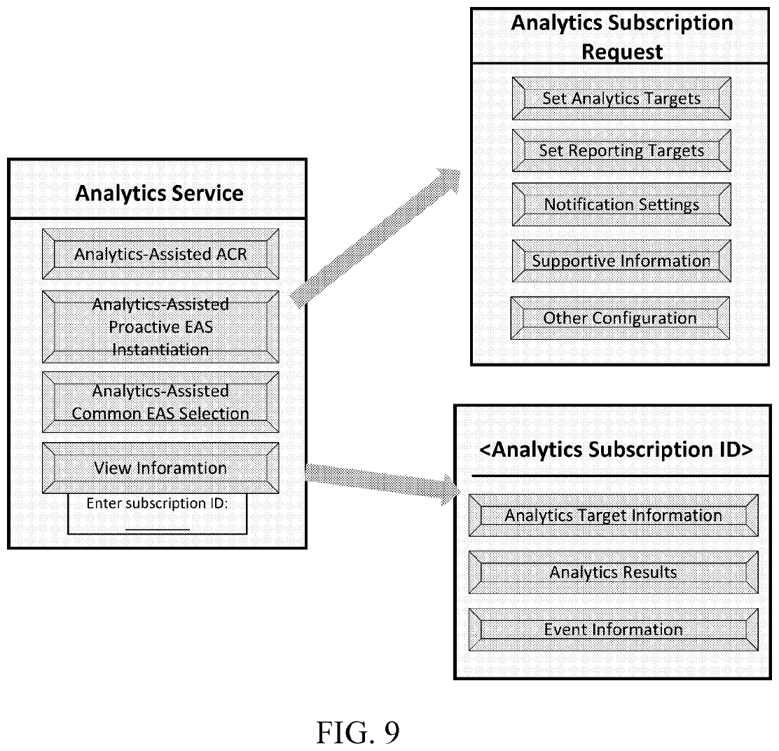

FIG. 9 depicts an example graphical user interface (GUI) for the EEL to configure analytics service for service continuity.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V21). Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

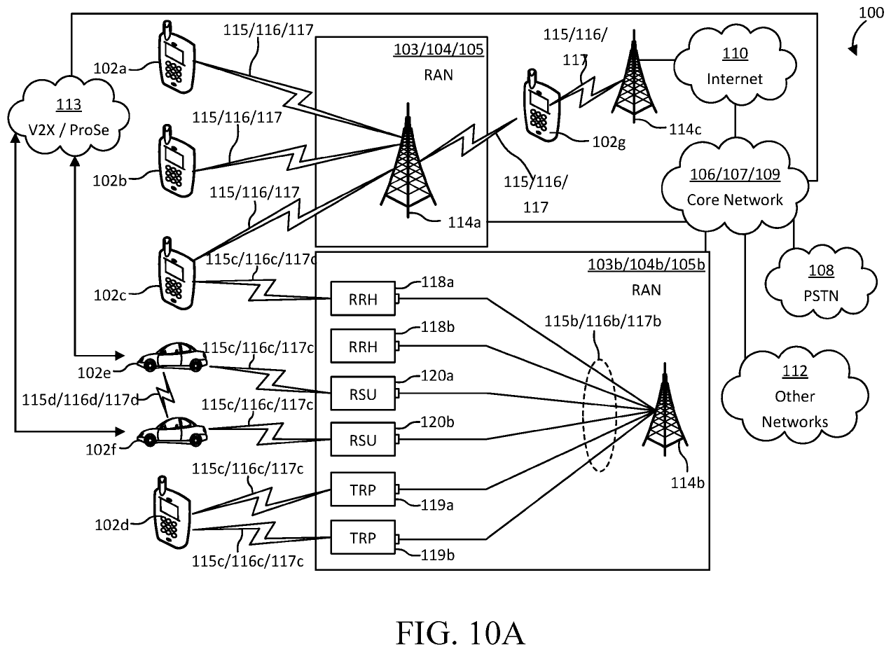

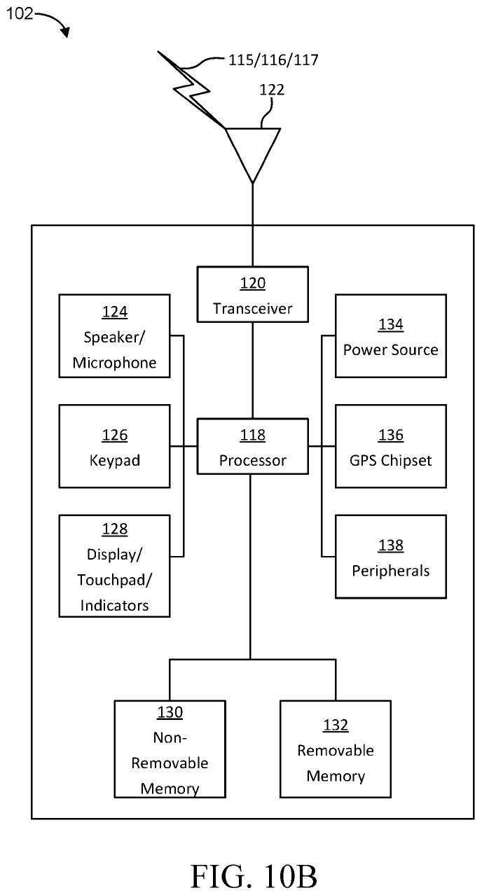

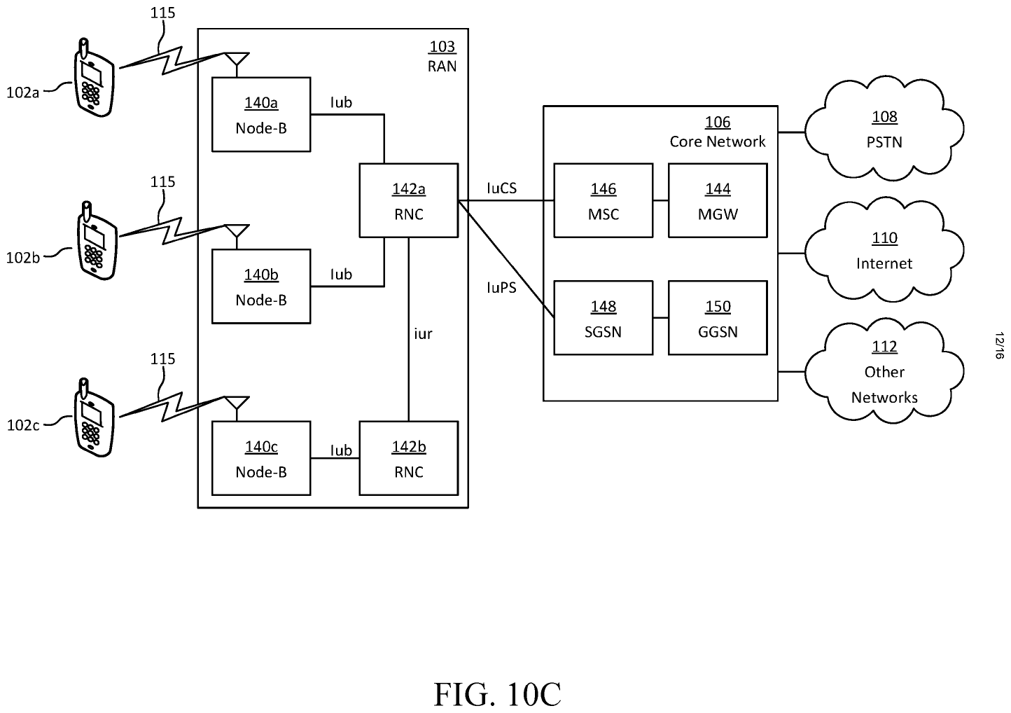

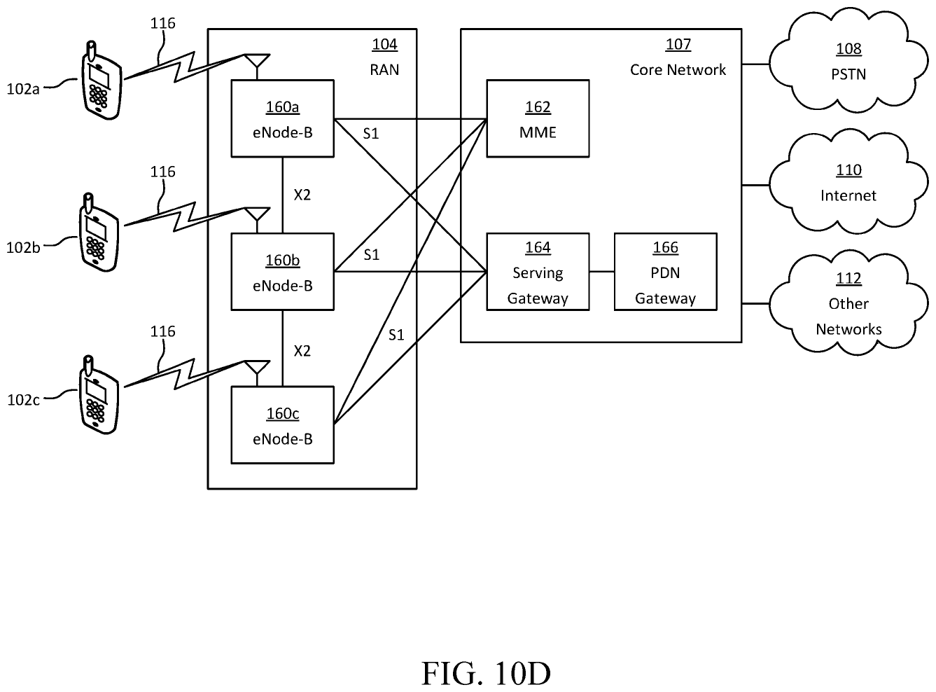

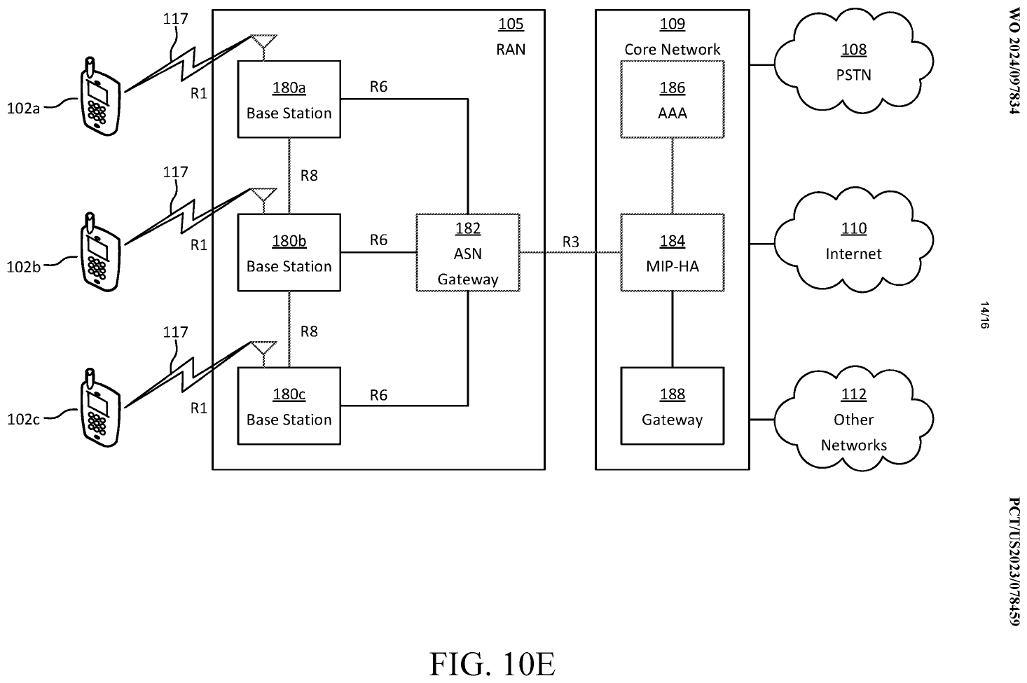

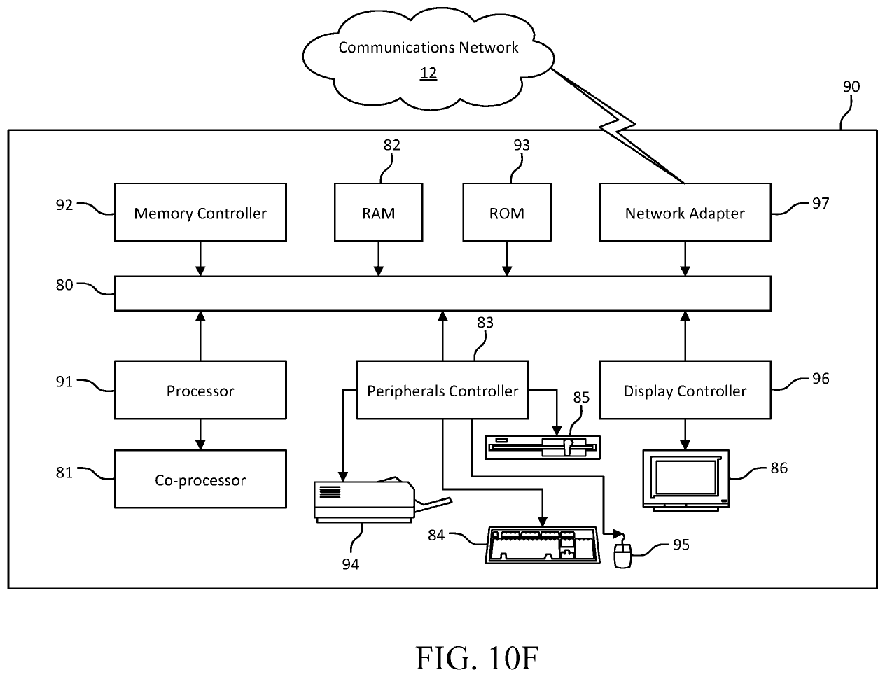

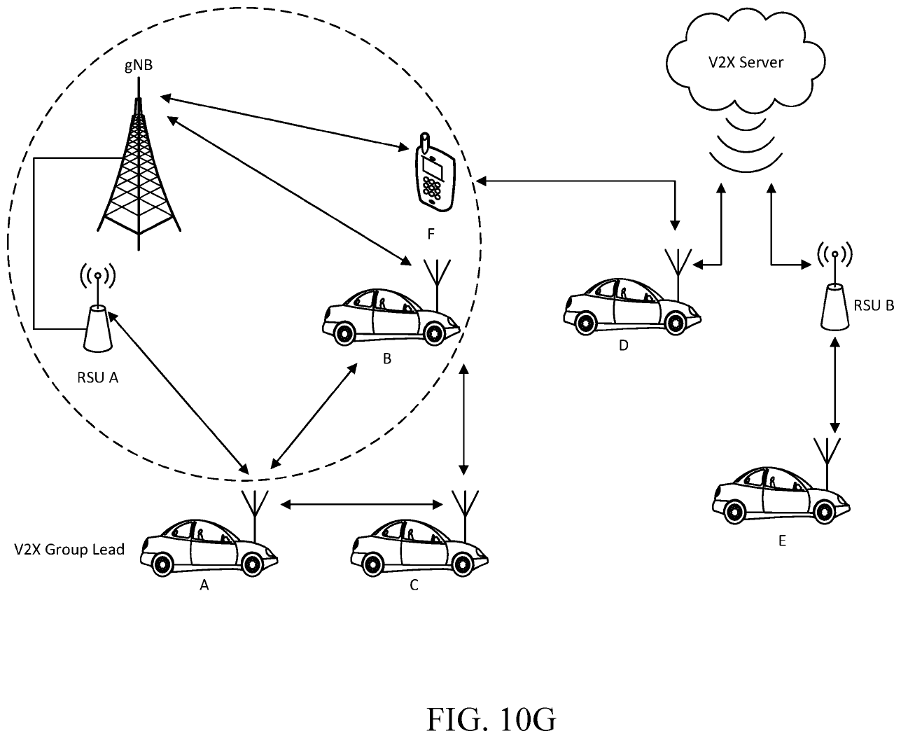

FIG. 10A illustrates an example communications system 100 in which the methods and apparatuses described and claimed herein may be an aspect of. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b. 102c. 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 10A-10E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b. TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a. 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a. 119b and RSUs 120a, 120b, in the RAN 103b/104b/105b and the WTRUs 102c, 102d. 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In some cases, the base station 114a in the RAN 103/104/105 and the WTRUs 102a. 102b, 102c, or RRHs 118a, 118b, TRPs 119a, 119b and/or RSUs 120a. 120b, in the RAN 103b/104b/105b and the WTRUs 102c, 102d, 102e. 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM). Enhanced Data rates for GSM Evolution (EDGE), GSM EDGE (GERAN), and the like.

The base station 114c in FIG. 10A may be a wireless router, Home Node B, Home eNode B, or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, etc.) to establish a picocell or femtocell. As shown in FIG. 10A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 10A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a. 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b. 102c, 102d, and 102e may include multiple transceivers for communicating with different wireless networks over different wireless links. For example, the WTRU 102e shown in FIG. 10A may be configured to communicate with the base station 114a, which may employ a cellular-based radio technology, and with the base station 114c, which may employ an IEEE 802 radio technology.

FIG. 10B is a block diagram of an example apparatus or device configured for wireless communications in accordance with the aspects illustrated herein, such as for example, a WTRU 102. As shown in FIG. 10B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 10B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 10B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR, UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 10B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 10C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 10C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 10C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a. 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 10C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b. 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 10D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 10D, the eNode-Bs 160a, 160b, 160c may communicate with one another over an X2 interface.

The core network 107 shown in FIG. 10D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 10E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 10E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 10E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 10E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 10A, 10C, 10D, and TOE are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 10A, JOB, 10C, 10D, and TOE are provided by way of example only, and it is understood that the subject matter disclosed and claimed herein may be embodied or implemented in any similar communication system, whether presently defined or defined in the future.

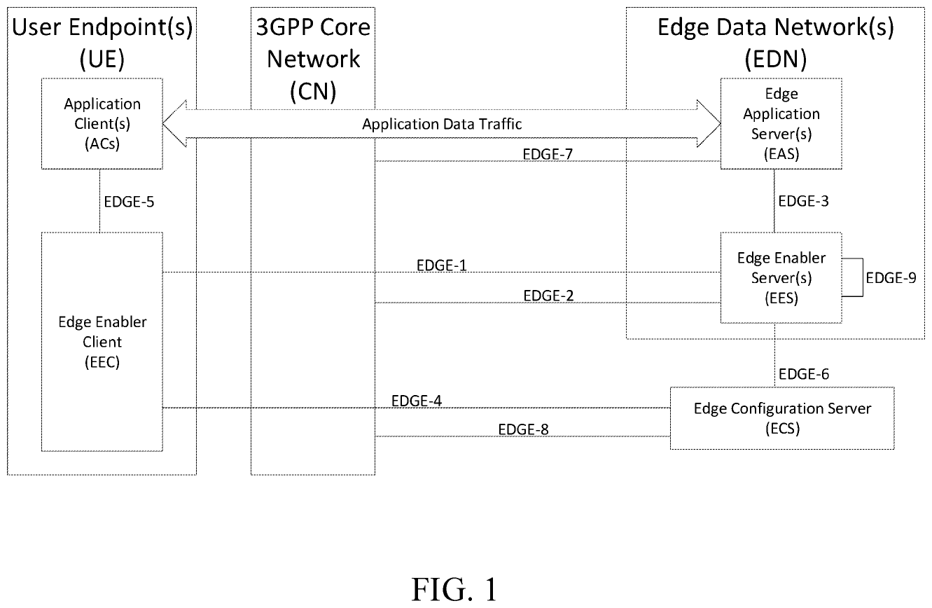

FIG. 10F is a block diagram of an exemplary computing system 90 in which one or more apparatuses of the communications networks illustrated in FIGS. 10A, 1° C., 10D and TOE may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109. PSTN 108, Internet 110, or Other Networks 112 of FIGS. 10A, 10B, 10C. 10D, and 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 10G illustrates an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals.

Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Definitions

Provided below are definitions for abbreviations found within the body of the disclosure.

| | |
|---|---|
| 3GPP | Third Generation Partnership Project |
| 5GS | 5G System |
| AC | Application Client |
| ACR | Application Context Relocation |
| ADAES | Application Data Analytics Enablement Service |
| AF | Application Function |
| API | Application Programming Interface |
| AS | Application Server |
| CAPIF | Common API Framework |
| CN | Core Network |
| EAS | Edge Application Server |
| EDN | Edge Data Network |
| EEC | Edge Enabler Client |
| EEL | Edge Enabler Layer |
| EES | Edge Enabler Server |
| ECS | Edge Configuration Server |
| GUI | Graphical User Interface |
| KPI | Key Performance Indicator |
| NWDAF | Network Data Analytics Function |
| QoS | Quality of Service |
| S-EES/EAS | Source EES/EAS |
| SEAL | Service Enabler Architecture Layer for Verticals |
| T-EES/EAS | Target EES/EAS |
| UAV | Uncrewed Aerial Vehicle |
| UE | User Equipment |
| V2X | Vehicle-to-Everything |
| VAL | Vertical Application Layer |

What is claimed:

1. A method performed by an edge enabler server (EES) to support a user device that is receiving service from an edge application server (EAS), comprising:
sending, to an analytics service, a first message indicating a request for predicting a service continuity event, wherein the first message comprises trigger conditions of the service continuity event:
receiving, from the analytics service, a second message comprising a predicted timing of the service continuity event and analytics information of one or more target EESs or target EASs associated with the service continuity event;
selecting a target EES or EAS based on the received analytics information; and
sending, to the analytics service, a third message comprising a notification of the service continuity event and the selected target EES or EAS.

2. The method of claim 1, wherein the trigger conditions of the service continuity event are associated with a load of one or more EESs or EASs.

3. The method of claim 1, wherein the first message further comprises a list of candidate EESs or EASs as a target of the service continuity event.

4. The method of claim 1, wherein the second message further comprises a list of suggested EESs or EASs as a target of the service continuity event.

5. The method of claim 1, further comprising:
receiving, from the analytics service, a fourth message comprising updated analytics information associated with the service continuity event;
determining, based on the fourth message, one or updates to a plan corresponding to the service continuity event; and
sending, to the analytics service, a fifth message indicating the determination.

6. The method of claim 1, further comprising:
sending, to the selected target EES, a message comprising a request to discover an EAS as a target of the service continuity event.

7. The method of claim 1, further comprising:
sending, to the selected target EES, a message comprising a request to instantiate an EAS as a target of the service continuity event.

8. An apparatus comprising an edge enabler server (EES), further comprising:
a processor;
memory; and
computer-executable instructions that, when executed by the processor, causes:
sending, to an analytics service, a first message indicating a request for predicting a service continuity event, wherein the first message comprises trigger conditions of the service continuity event;
receiving, from the analytics service, a second message comprising a predicted timing of the service continuity event and analytics information of one or more target EESs or target EASs associated with the service continuity event;
selecting a target EES or EAS based on the received analytics information; and
sending, to the analytics service, a third message comprising a notification of the service continuity event and the selected target EES or EAS.

9. The apparatus of claim 8, wherein the trigger conditions of the service continuity event are associated with a load of one or more EESs or EASs.

10. The apparatus of claim 8, wherein the first message further comprises a list of candidate EESs or EASs as a target of the service continuity event.

11. The apparatus of claim 8, wherein the second message further comprises a list of suggested EESs or EASs as a target of the service continuity event.

12. The apparatus of claim 8, wherein the computer-executable instructions, when executed by the processor, further cause:
receiving, from the analytics service, a fourth message comprising updated analytics information associated with the service continuity event:
determining, based on the fourth message, one or updates to a plan corresponding to the service continuity event; and
sending, to the analytics service, a fifth message indicating the determination.

13. The apparatus of claim 8, wherein the computer-executable instructions, when executed by the processor, further cause:
sending, to the selected target EES, a message comprising a request to discover an EAS as a target of the service continuity event.

14. The apparatus of claim 8, wherein the computer-executable instructions, when executed by the processor, further cause:
sending, to the selected target EES, a message comprising a request to instantiate an EAS as a target of the service continuity event.

15. A non-transitory, computer-readable medium storing computer-executable instructions that, when executed by a processor, cause:
sending, to an analytics service, a first message indicating a request for predicting a service continuity event, wherein the first message comprises trigger conditions of the service continuity event;
receiving, from the analytics service, a second message comprising a predicted timing of the service continuity event and analytics information of one or more target EESs or target EASs associated with the service continuity event:
selecting a target EES or EAS based on the received analytics information; and
sending, to the analytics service, a third message comprising a notification of the service continuity event and the selected target EES or EAS.

16. The non-transitory, computer-readable medium of claim 15, wherein the trigger conditions of the service continuity event are associated with a load of one or more EESs or EASs.

17. The non-transitory, computer-readable medium of claim 15, wherein the first message further comprises a list of candidate EESs or EASs as a target of the service continuity event.

18. The non-transitory, computer-readable medium of claim 15, wherein the second message further comprises a list of suggested EESs or EASs as a target of the service continuity event.

19. The non-transitory, computer-readable medium of claim 15, wherein the computer-executable instructions, when executed by the processor, further cause:
receiving, from the analytics service, a fourth message comprising updated analytics information associated with the service continuity event;
determining, based on the fourth message, one or updates to a plan corresponding to the service continuity event; and
sending, to the analytics service, a fifth message indicating the determination.

20. The apparatus of claim 15, wherein the computer-executable instructions, when executed by the processor, further cause:
sending, to the selected target EES, a message comprising a request to discover an EAS as a target of the service continuity event.
